(19) United States
(12) Patent Application Publication
(10) Pub. No.: US 2019/0097561 A1
(43) Pub. Date: Mar. 28, 2019

(54) INVERTER DRIVER

(71) Applicant: AISIN AW CO., LTD., Anjo-shi, Aichi-ken (JP)

(72) Inventor: Masakazu SATO, Anjo (JP)

(73) Assignee: AISIN AW CO., LTD., Anjo-shi, Aichi-ken (JP)

(21) Appl. No.: 16/079,855

(22) PCT Filed: Mar. 3, 2017
(86) PCT No.: PCT/JP2017/008515

§ 371 Date: Aug. 24, 2018

(30) Foreign Application Priority Data
Mar. 25, 2016 (JP) 2016-061871

(51) Int. Cl. H02P 27/06; H02P 29/024; H02M 1/084; H02M 7/5387

(52) U.S. Cl. CPC H02P 27/06; H02M 7/53871; H02M 1/084; H02P 29/0241

(57) ABSTRACT

An inverter driver where one of the upper driving circuit and the lower driving circuit is a first driving circuit, and the other of the upper driving circuit and the lower driving circuit is a second driving circuit, and the resetting circuit is connected to each of the first driving circuits for all of the phases, and the control signal changing circuits are each connected between the inverter controller and an associated one of the second driving circuits for all of the phases.

### BACKGROUND

The present disclosure relates to an inverter driver including driving circuits to transmit driving signals to a plurality of switching elements included in an inverter circuit that converts alternating-current power to direct-current power and converts direct-current power to alternating-current power.

When a system including an inverter circuit that is connected to a direct-current power supply and an alternating-current electrical device and is configured to convert direct-current power to alternating-current power and convert alternating-current power to direct-current power encounters a situation where continuation of operation is not preferable, failsafe control is often exercised over the inverter circuit. Examples of such failsafe control include shutdown control and active short-circuit control. The term “shutdown control” refers to control that involves turning off all of switching elements included in the inverter circuit. The term “active short-circuit control” refers to control that involves turning on all of upper switching elements included in the inverter circuit and connected to a direct-current positive electrode while turning off all of lower switching elements included in the inverter circuit and connected to a direct-current negative electrode, or turning on all of the lower switching elements while turning off all of the upper switching elements. For example, when the alternating-current electrical device is a rotating electric machine, exercising active short-circuit control causes an electric current to flow between the inverter circuit and a stator coil of the rotating electric machine in a circulating manner.

Japanese Patent Application Publication No. 2012-186871 whose number is given below discloses a power converter that exercises such active short-circuit control in the event of an overvoltage. (The reference numerals in parentheses in the description of background art below correspond to those used in Japanese Patent Application Publication No. 2012-186871). The power converter includes a controller (microcontroller (302)). When another controller to control an inverter circuit has lost a power supply (control power supply), the microcontroller (302) is operated by power generated in accordance with direct-current power supplied from another power supply (high voltage power supply (106) connected to the direct-current side of the inverter circuit) (for example, paragraphs [0033] to [0035] and FIG. 4 of Japanese Patent Application Publication No. 2012-186871). For example, when the control power supply is lost at a time (t1), a higher level controller exercises control so as to break an electrical connection between the high voltage power supply (106) and the inverter circuit (300). Upon being notified of a defective condition of the control power supply, the microcontroller (302) outputs, to driver circuits (121) of the inverter circuit (300), a control signal for exercising active short-circuit control (three-phase short control) at a time (t2) after a lapse of a predetermined delay time (for example, paragraphs [0048] to [0051] and FIG. 7 of Japanese Patent Application Publication No. 2012-186871),

When the electrical connection between the high voltage power supply (106) and the inverter circuit (300) is broken, regenerated power provided from a rotating electric machine (three-phase motor (105)) does not return to the high voltage power supply (106), so that a smoothing capacitor (109) connected to the direct-current side of the inverter circuit (300) is charged. Specifically, during a time period between the time (t1) at which the control power supply is lost and the electrical connection between the high voltage power supply (106) and the inverter circuit (300) is broken and the time (t2) at which active short-circuit control starts, the smoothing capacitor (109) is charged with regenerated power provided from the rotating electric machine (three-phase motor (105)). This charging may increase the inter-terminal voltage of the smoothing capacitor (109), i.e., the voltage of the direct-current side of the inverter circuit (300) (direct-current link voltage). In order to reduce the extent of increase, the capacitance of the smoothing capacitor (109) may be increased. Increasing the capacitance of the smoothing capacitor (109), however, may result in an increase in size of the capacitor or an increase in cost of components. Accordingly, it is preferable to reduce the amount of increase in the direct-current link voltage before active short-circuit control starts.

### SUMMARY

An exemplary aspect of the disclosure causes an inverter circuit to quickly shift to an active short-circuit state when conditions for exercising active short-circuit control are satisfied.

In view of the above, an aspect of the present disclosure provides an inverter driver including driving circuits configured to transmit driving signals to a plurality of switching elements included in an inverter circuit. The inverter circuit is connected to a direct-current power supply and an alternating-current rotating electric machine and configured to convert multi-phase alternating-current power to direct-current power and convert direct-current power to multi-phase alternating-current power.

The inverter circuit includes a plurality of arms each provided for an associated one of alternating-current phases. The arms each include a series circuit of an upper switching element and a lower switching element.

The driving circuits are each configured to relay a switching control signal so as to transmit the driving signal to an associated one of the switching elements. The switching control signal is output from an inverter controller that controls the inverter circuit. The driving circuits include an upper driving circuit to transmit the driving signal to the associated upper switching element, and a lower driving circuit to transmit the driving signal to the associated lower switching element.

The inverter driver further includes an overvoltage protector, a resetting circuit, and control signal changing circuits.

The overvoltage protector is configured to output an overvoltage protection signal when a voltage of a direct-current side of the inverter circuit is equal to or higher than a preset overvoltage threshold value.

The resetting circuit is configured to set, in accordance with at least the overvoltage protection signal, a signal level of the driving signal to be output from each of the associated driving circuits at a signal level that turns off the associated switching element.

The control signal changing circuits are each connected between the inverter controller and the associated driving circuit. The control signal changing circuits are each configured to transmit, instead of the switching control signal, a control signal to the associated driving circuit in accordance with the overvoltage protection signal. The control signal has a logical level that turns on the associated switching element irrespective of a logical level of the switching control signal.

One of the upper driving circuit and the lower driving circuit is a first driving circuit. The other one of the upper driving circuit and the lower driving circuit is a second driving circuit.

The resetting circuit is connected to each of the first driving circuits for all of the phases. The control signal changing circuits are each connected between the inverter controller and an associated one of the second driving circuits for all of the phases.

In this configuration, a signal to be input to each second driving circuit immediately changes to an active short-circuit control signal in accordance with the overvoltage protection signal, without a controller such as the inverter controller being involved. Thus, in the course of active short-circuit control, the switching elements that should be turned on are quickly turned on. The upper and lower switching elements of each arm need to be prevented from being simultaneously turned on and short-circuited. In other words, in the course of active short-circuit control, the switching element of each arm different from the switching element that should be turned on needs to be turned off. In the above configuration, the signal level of an output from each first driving circuit is immediately set at a signal level that turns off the associated switching element in accordance with the overvoltage protection signal, without a controller such as the inverter controller being involved. Accordingly, each of the arms is brought to a state where active short-circuit control is immediately exercised in accordance with the overvoltage protection signal, i.e., an active short-circuit state, without a controller such as the inverter controller being involved. Consequently, the above configuration enables the inverter circuit to quickly shift to the active short-circuit state when conditions for exercising active short-circuit control are satisfied (e.g., when the overvoltage protection signal is output).

Further features and advantages of the inverter driver will become clear from the following description of the embodiments with reference to the drawings.

### BRIEF DESCRIPTION OF THE DRAWINGS

FIG. 1 is a circuit block diagram of an exemplary system configuration of a rotating electric machine control apparatus.

FIG. 2 is a circuit block diagram of a preferable exemplary configuration of an inverter driver.

FIG. 3 is a circuit block diagram of an exemplary configuration of the inverter driver, schematically illustrating the principles of the inverter driver.

FIG. 4 is a block diagram of an exemplary configuration of a multi-phase inverter driver.

FIG. 5 is a circuit diagram of another exemplary configuration of a control signal changing circuit.

FIG. 6 is a circuit diagram of still another exemplary configuration of the control signal changing circuit.

FIG. 7 is a circuit block diagram of the inverter driver including a resetting circuit having another exemplary configuration.

### DETAILED DESCRIPTION OF EMBODIMENTS

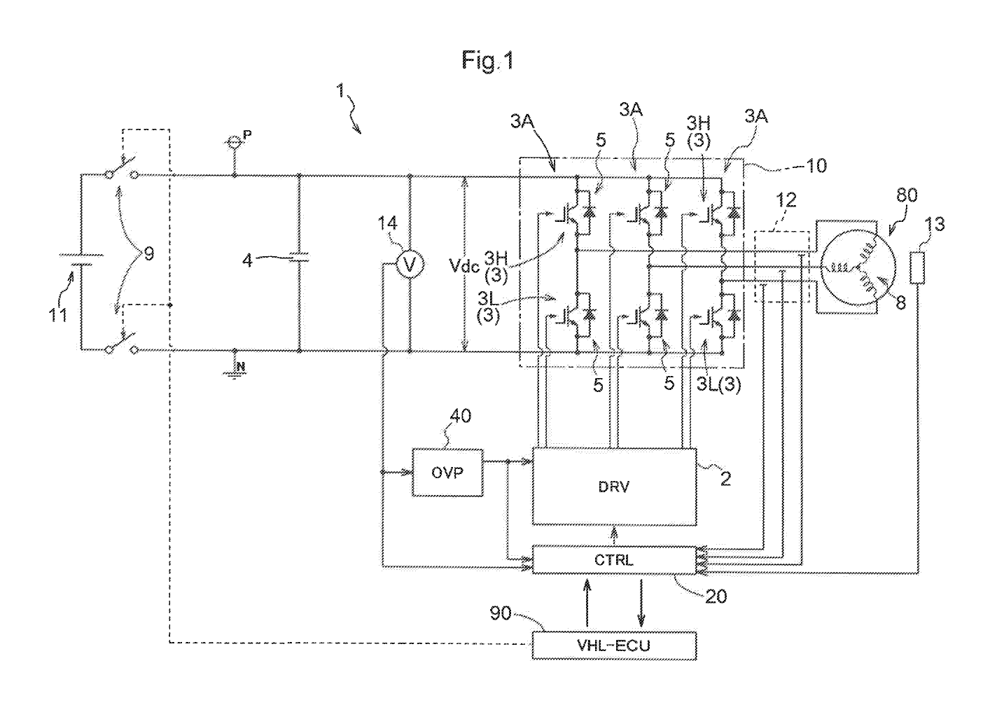

An embodiment of an inverter driver will be described below with reference to the drawings on the assumption that the inverter driver is used in a rotating electric machine control apparatus for controlling driving of a rotating electric machine. The circuit block diagram of FIG. 1 schematically illustrates a system configuration of a rotating electric machine control apparatus 1. As illustrated in FIG. 1, the rotating electric machine control apparatus 1 includes an inverter circuit 10 to convert direct-current power to multi-phase alternating-current power and convert multi-phase alternating-current power to direct-current power. The present embodiment illustrates the inverter circuit 10 that is connected to an alternating-current rotating electric machine 80 and a high voltage battery 11 (direct-current power supply) and is configured to convert multi-phase alternating-current power to direct-current power and convert direct-current power to multi-phase alternating-current power. The inverter circuit 10 is connected through a contactor 9 to the high voltage battery 11 and connected to the alternating-current rotating electric machine 80 so as to convert direct-current power to multi-phase alternating-current power (three-phase alternating-current power in this embodiment) and convert multi-phase alternating-current power to direct-current power. The inverter circuit 10 includes a plurality of arms 3A (three arms 3A in this embodiment) each provided for an associated one of alternating-current phases. The arms 3A each include a series circuit of an upper switching element 3H and a lower switching element 3L.

The rotating electric machine 80 may be used as a driving force source for a vehicle, such as a hybrid car or an electric car, for example. The rotating electric machine 80 may also function as an electric motor or a generator. The rotating electric machine 80 converts power supplied from the high voltage battery 11 through the inverter circuit 10 into power for driving the wheel(s) of a vehicle (power running). The rotating electric machine 80 converts a rotational driving force transmitted from an internal combustion engine (not illustrated) or the wheel(s) into power, and charges the high voltage battery 11 with the power through the inverter circuit 10 (regeneration). The high voltage battery 11 includes, for example, a secondary cell (battery), such as a nickel-metal hydride battery or a lithium ion battery, and/or an electric double layer capacitor. When the rotating electric machine 80 is a vehicle driving force source, the high voltage battery 11 is a high voltage, high capacitance direct-current power supply, and the rated power supply voltage of the high voltage battery 11 ranges from 200 V to 400 V, for example.

A voltage across a positive electrode power supply line P and a negative electrode power supply line N on the direct-current side of the inverter circuit 10 will hereinafter be referred to as a “direct-current link voltage Vdc”. The direct-current side of the inverter circuit 10 includes a smoothing capacitor (direct-current link capacitor 4) to smooth the direct-current link voltage Vdc. The direct-current link capacitor 4 stabilizes the direct-current voltage (direct-current link voltage Vdc) that varies in accordance with a change in power consumption by the rotating electric machine 80.

As illustrated in FIG, 1, the contactor 9 is provided between the high voltage battery 11 and the inverter circuit 10. Specifically, the contactor 9 is disposed between the direct-current link capacitor 4 and the high voltage battery 11. The contactor 9 is able to break an electrical connection between the high voltage battery 11 and an electric circuit system of the rotating electric machine control apparatus 1 (including the direct-current link capacitor 4 and the inverter circuit 10). In other words, the inverter circuit 10 is connected to the rotating electric machine 80 and connected through the contactor 9 to the high voltage battery 11. When the contactor 9 is in a connected state (closed state), the high voltage battery 11 is electrically connected to the inverter circuit 10 (and the rotating electric machine 80). When the contactor 9 is in a disconnected state (opened state), the high voltage battery 11 is electrically disconnected from the inverter circuit 10 (and the rotating electric machine 80).

In the present embodiment, the contactor 9 is a mechanical relay that opens and closes in accordance with a command from a vehicle electronic control unit (ECU) 90 (VHL-ECU) that is one of higher level controllers provided in the vehicle. Such a mechanical relay is referred to as a system main relay (SMR), for example. When an ignition key (IG key) of the vehicle is in an on state (effective state), the relay contact points of the contactor 9 close, so that the contactor 9 enters a conductive state (connected state). When the IG key is in an off state (ineffective state), the relay contact points of the contactor 9 open, so that the contactor 9 enters a non-conductive state (disconnected state).

As previously mentioned, the inverter circuit 10 converts direct-current power having the direct-current link voltage Vdc to alternating current power having n phases (where n is a natural number) so as to supply the alternating-current power to the rotating electric machine 80, and converts alternating-current power generated by the rotating electric machine 80 to direct-current power so as to supply the direct-current power to the direct-current power supply. In this embodiment, n is three. The inverter circuit 10 is configured to include a plurality of switching elements 3. Power semiconductor elements operable at high frequencies are preferably used as the switching elements 3. Examples of such power semiconductor elements include an insulated gate bipolar transistor (IGBT), a power metal oxide semiconductor field effect transistor (MOSFET), a silicon carbide-metal oxide semiconductor FET (SiC-MOSFET), an SiC-static induction transistor (SiC-SIT), and a gallium nitride MOSFET (GaN-MOSFET). As illustrated in FIG. 1, IGBTs are used as the switching elements 3 in the present embodiment.

As is well known, the inverter circuit 10 to convert direct-current power to multi-phase alternating-current power and convert multi-phase alternating-current power to direct-current power, for example, includes a bridge circuit including the arms 3A, the number of which corresponds to the number of phases of the rotating electric machine 80. When the rotating electric machine 80 has three phases, the bridge circuit is configured such that each of the series circuits (arms 3A) is provided for an associated one of U phase, V phase, and W phase stator coils 8. Intermediate points on the arms 3A, i.e., the points of contact between the switching elements 3 (upper switching elements 3H) adjacent to the positive electrode power supply line P and the switching elements 3 (lower switching elements 3L) adjacent to the negative electrode power supply line N, are each connected to an associated one of the three-phase stator coils 8 of the rotating electric machine 80. Each of the switching elements 3 is connected in parallel to an associated one of freewheel diodes 5 such that a direction from a negative electrode “N” to a positive electrode “P” (i.e., a direction from a lower stage to an upper stage) is a forward direction.

As illustrated in FIG. 1, the inverter circuit 10 is controlled by an inverter controller 20 (CTRL). The inverter controller 20 is configured such that a logic circuit of a microcomputer, for example, serves as a core component. In one example, the inverter controller 20 exercises, using a vector control method, current feedback control in accordance with a target torque for the rotating electric machine 80 provided in the form of a request signal from, for example, a different controller, such as the vehicle ECU 90, so as to control the rotating electric machine 80 through the inverter circuit 10. A current sensor 12 detects an actual current flowing through the stator coil 8 of each phase of the rotating electric machine 80. The inverter controller 20 receives results of detection by the current sensor 12. A rotation sensor 13, such as a resolver, for example, detects a magnetic pole position of a rotor of the rotating electric machine 80 at each time point. The inverter controller 20 receives results of detection by the rotation sensor 13. Using the results of detection by the current sensor 12 and the rotation sensor 13, the inverter controller 20 exercises current feedback control. The inverter controller 20 is configured to include various functional components for current feedback control. The functional components are provided by cooperation between hardware and software (program) for a microcomputer, for example. Current feedback control is known in the art and will thus not be described in detail.

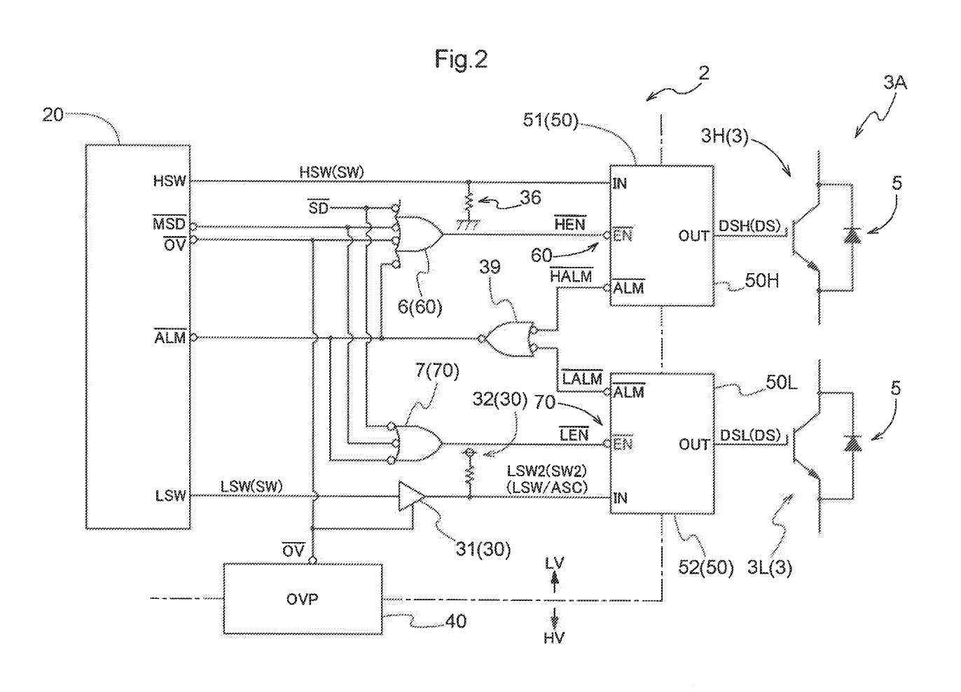

Control terminals of the switching elements 3 (e.g., gate terminals of the IGBTs) included in the inverter circuit 10 are connected to the inverter controller 20 through a driver 2 (DRV) that functions as an inverter driver. Thus, the control terminals of the switching elements 3 are individually brought under switching control. The vehicle ECU 90 and the inverter controller 20 that generates switching control signals are included in a low voltage system circuit LV illustrated in FIG. 2, such that a microcomputer, for example, serves as the core. The low voltage system circuit LV significantly differs in operating voltage (circuit power supply voltage) from a high voltage system circuit HV that includes the inverter circuit 10 and serves to drive the rotating electric machine 80. In many cases, the vehicle is equipped with not only the high voltage battery 11 but also a low voltage battery (not illustrated) that is a power supply whose voltage is lower than the voltage of the high voltage battery 11. The voltage of the low voltage battery ranges from 12 [V] to 24 [V], for example. The vehicle ECU 90 and the inverter controller 20 each have an operating voltage of 5 [V] or 3.3 [V], for example, and are operated upon receiving power from the low voltage battery.

Thus, the rotating electric machine control apparatus 1 includes the driver 2 to enhance the driving capability of a switching control signal SW for each of the switching elements 3 and relay the resulting switching control signal SW to an associated one of the switching elements 3. The switching control signals SW are gate driving signals when the switching elements 3 are IGBTs. The term “driving capability” refers to the capability to operate a circuit in a subsequent stage. The driving capability is expressed in terms of voltage amplitude or output current, for example. The switching control signals SW generated by the inverter controller 20 of the low voltage system circuit LV are supplied through the driver 2 to the inverter circuit 10 in the form of driving signals DS for the high voltage system circuit HV. The low voltage system circuit LV and the high voltage system circuit HV are often insulated from each other. In this case, the driver 2 is configured to use, for example, an insulating element, such as a photocoupler or a transformer, and/or a driver IC. As illustrated in FIG. 2, the present embodiment illustrates the driver 2 including driving circuits 50 that use driver ICs.

For the sake of simplification, FIG. 2 illustrates typical portions of the inverter circuit 10, the inverter controller 20, and the driver 2, for example, that are associated with the arm 3A for one of the alternating-current phases. The driving circuits 50 that use the driver ICs are each provided for an associated one of the switching elements 3. An upper driving circuit 50H is provided for the upper switching element 3H. A lower driving circuit 50L is provided for the lower switching element 3L. Each driving circuit 50 includes a signal input terminal IN, a signal output terminal OUT, an enable input terminal EN, and an alarm output terminal ALM. A signal to be input to the enable input terminal EN and a signal to be output from the alarm output terminal ALM are low-active (negative logic) signals. The term “low-active signal” refers to a signal that is effective when its logical level is low (negative). In other words, the term “low-active signal” refers to a signal whose logical level is high (positive) under normal conditions and is low (negative) when a meaningful output is produced. The low-active signals in the drawings are each marked with a “bar” over its signal name, but these signals are simply indicated by only signal names in the specification. In FIGS. 2 to 4, not only signal names “EN” and “ALM” but also other signal names, such as “OV”, “SD”, and “MSD”, are each marked with a “bar”. These signals are also low-active signals and indicated by only signal names in the specification.

The switching control signals SW output from the inverter controller 20 are input to the signal input terminals IN of the driving circuits 50. “HSW” represents an upper switching control signal to control the upper switching element 3H. “LSW” represents a lower switching control signal to control the lower switching element 3L. The switching control signals SW (HSW, LSW) input to the driving circuits 50 are given the driving capability (e.g., voltage amplitude or output current) to drive the gate terminals of the switching elements 3 by the driving circuits 50. The resulting signals are output from the signal output terminals OUT in the form of the driving signals DS (i.e., an upper driving signal DSH and a lower driving signal DSL).

Each driving circuit 50 incorporates a diagnostic circuit. Each diagnostic circuit detects, for example, a state where a gate driving voltage is low (i.e., a state where a voltage amplitude necessary for the gate driving signal cannot be provided), a state where an overcurrent develops in the switching element 3, or a state where a control circuit temperature of the driving circuit 50 is on the rise. Upon detecting such a state, each diagnostic circuit generates and outputs an alarm signal (HALM or LALM in FIG. 2). Although not illustrated, occurrence of an overcurrent is determined in accordance with whether the inter-terminal voltage of an external overcurrent detection shunt resistor, for example, is higher than a preset value.

The signal input to each enable input terminal EN is a signal (enable signal “HEN” or LEN”) to make a determination of whether a signal whose logical level is the same as the logical level of a signal input to the signal input terminal IN should be output to the signal output terminal OUT of the driving circuit 50. In the present embodiment, when the enable signal “HEN” or “LEN” is low, the driving signal DS (DSH or DSL) whose logical level is the same as the logical level of the signal input to the signal input terminal IN is output from the signal output terminal OUT. When the enable signal “HEN” or “LEN” is high, the driving signal DS (DSH or DSL) held in an ineffective state (which is a low state in the present embodiment) is output from the signal output terminal OUT.

As illustrated in FIGS. 1 and 2, the rotating electric machine control apparatus 1 according to the present embodiment includes an overvoltage protector 40 (OVP). The overvoltage protector 40 outputs an overvoltage protection signal OV when the voltage of the direct-current side of the inverter circuit 10 (i.e., the direct-current link voltage Vdc) is equal to or higher than a preset overvoltage threshold value. The overvoltage protection signal OV is input to the inverter controller 20, control signal changing circuits 30, and a resetting circuit 60 (RST). The control signal changing circuits 30 and the resetting circuit 60 will be described below.

The following description discusses an exemplary case where an overvoltage occurs. As previously described, the contactor 9 enters the connected state when the ignition key (IG key) of the vehicle is in the on state (effective state), and enters the disconnected state when the IG key is in the off state (ineffective state). During normal operation, the contactor 9 is controlled such that the contactor 9 enters the opened state or closed state in accordance with the state of the IG key. When the IG key is in the on state, however, the contactor 9 may enter the disconnected state owing to a defective condition of an electrical system or a large impact on the vehicle, for example. The contactor 9 may enter the disconnected state, for example, when supply of power to the contactor 9 is shut off, a defective condition of a driving circuit for the contactor 9 occurs, a wire of a circuit adjacent to the contactor 9 is broken, or the contactor 9 mechanically moves owing to vibration, impact or other causes. When the contactor 9 enters the disconnected state, the contactor 9 shuts off supply of power from the high voltage battery 11 to the inverter circuit 10. Concurrently, the contactor 9 shuts off regeneration of power from the rotating electric machine 80 to the high voltage battery 11 through the inverter circuit 10.

If the rotating electric machine 80 is rotating in such a case, the rotating electric machine 80 continues rotating because of inertia. Through the inverter circuit 10, the direct-current link capacitor 4 may be charged with power accumulated in the stator coils 8, so that the inter-terminal voltage of the direct-current link capacitor 4 (i.e., the direct-current link voltage Vdc) may increase in a short time. Increasing the capacitance of the direct-current link capacitor 4 and enhancing the ability of the direct-current link capacitor 4 to withstand high voltage so as to cope with such an increase in the direct-current link voltage Vdc leads to an increase in capacitor size and makes it necessary to enhance the ability of the inverter circuit 10 to withstand high voltage. This consequently prevents size reduction of the rotating electric machine control apparatus 1 and affects component cost, manufacturing cost, and product cost.

Thus, when the contactor 9 enters the disconnected state, active short-circuit control may be exercised. Active short-circuit control exercised in this case is either upper active short-circuit control involving turning on the upper switching elements 3H of the arms 3A for all of the phases (three phases in this embodiment), or lower active short-circuit control involving turning on the lower switching elements 3L of the arms 3A for all of the phases (three phases). Exercising active short-circuit control causes power accumulated in each stator coil 8 to flow between each stator coil 8 and the associated switching element 3 of the inverter circuit 10 in a circulating manner. Energy of the current (current flowing in a circulating manner) is consumed by the switching elements 3 and the stator coils 8 owing to heat, for example.

For example, upon receiving the effective overvoltage protection signal OV, the inverter controller 20 sets the logical level of each switching control signal SW such that active short-circuit control is exercised, and outputs the resulting switching control signal SW. The inverter controller 20 outputs the switching control signals SW whose logical levels are such that all of the upper switching control signals HSW are high and all of the lower switching control signals LSW are low or such that all of the lower switching control signals LSV are high and all of the upper switching control signals HSW are low.

During a time period between occurrence of an overvoltage and output of the overvoltage protection signal OV from the overvoltage protector 40, however, the overvoltage protector 40 requires a detection time and a determination time. The inverter controller 20 that has received the overvoltage protection signal QV requires a calculation time before the inverter controller 20 outputs the switching control signals SW whose logical levels enable active short-circuit control. Thus, the direct-current link voltage Vdc may also increase during a time period between occurrence of an overvoltage and a time at which the inverter circuit 10 enters an active short-circuit state. Accordingly, the present embodiment involves providing the control signal changing circuits 30 and the resetting circuit 60 in the driver 2 so as to suppress such a voltage increase.

Each control signal changing circuit 30 is a circuit to transmit, instead of the switching control signal SW, a control signal SW2 to the associated driving circuit 50 in accordance with the overvoltage protection signal QV. The control signal SW2 has a logical level that turns on the associated switching element 3 irrespective of the logical level of the switching control signal SW. Thus, each control signal changing circuit 30 is connected between the inverter controller 20 and the associated driving circuit 50. The resetting circuit 60 is a circuit to set, in accordance with at least the overvoltage protection signal OV, the signal level of the driving signal DS to be output from the driving circuit 50 at a signal level that turns off the associated switching element 3.

As illustrated in FIG. 2, the resetting circuit 60 is configured to include a first OR circuit 6. The first OR circuit 6 is, for example, an OR circuit (NAND circuit) that receives negative logic signals. The first OR circuit 6 receives, in addition to the overvoltage protection signal OV, signals “SD”, “MDS”, and “ALM” that are negative logic signals similarly to the overvoltage protection signal OV. An output terminal of the resetting circuit 60 is connected to the enable input terminal EN of each upper driving circuit 50H. Each upper driving circuit 5011 is a first driving circuit 51 (which will be described below). The signal “SD” is a signal provided from, for example, the vehicle ECU 90 that is one of the higher level controllers. The signal “SD” is a command to shut down the rotating electric machine control apparatus 1. The signal “MSD” is a motor shut-down command MSD to shut down the rotating electric machine 80 (or the inverter circuit 10). The motor shut-down command MSD has a shut-down function similarly to the shut-down command SD, although the motor shut-down command MSD is output not from the vehicle ECU 90 but from the inverter controller 20. As previously described, the signal “ALM” is an alarm signal indicative of a diagnostic result obtained by the diagnostic circuit of each driving circuit 50. When one of the shut-down command “SD”, the motor shut-down command “MDS”, the alarm signal “ALM”, and the overvoltage protection signal OV is effective, an output from the resetting circuit 60 (i.e., the upper enable signal HEN) is ineffective. As previously mentioned, when an input to the enable input terminal EN of the driving circuit 50 is ineffective, the driving signal DS (upper driving signal DSH) output from the signal output terminal OUT of the driving circuit 50 is also ineffective and low. This turns off the switching element 3 that receives the driving signal DS from the driving circuit 50.

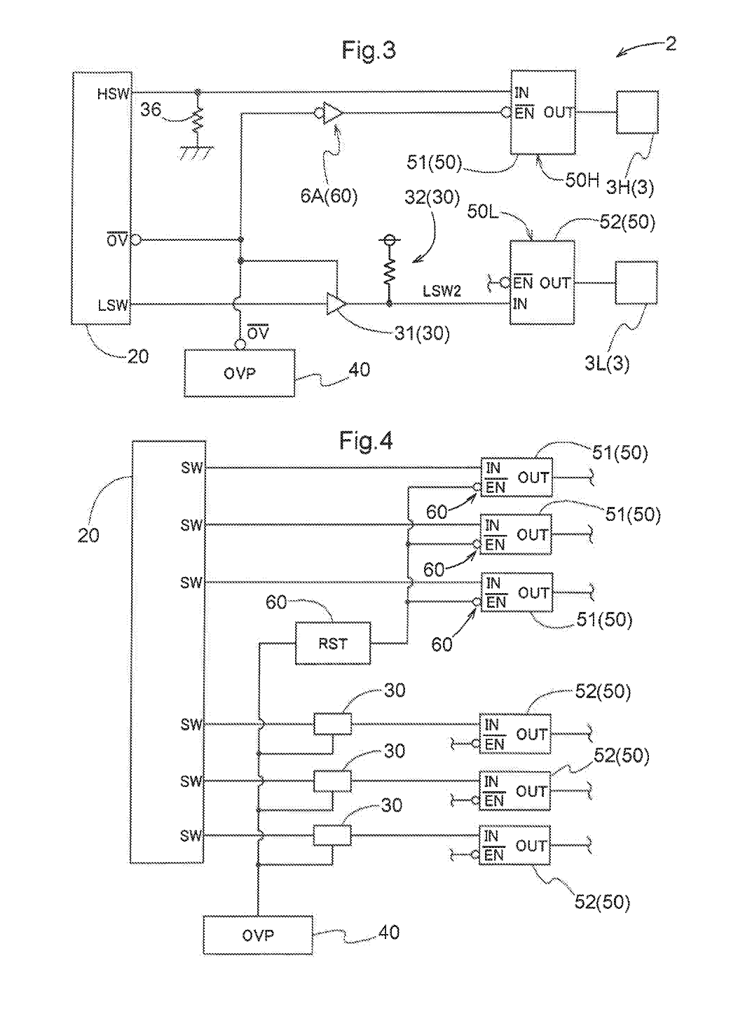

As previously described, the resetting circuit 60 sets, in accordance with at least the overvoltage protection signal OV, the signal level of the driving signal DS to be output from the driving circuit 50 at a signal level that turns off the associated switching element 3. Accordingly, a resetting signal (enable signal) to be output from the resetting circuit 60 does not necessarily have to be generated on the basis of the logical sum of a plurality of signals as illustrated in FIG. 2. The resetting signal (enable signal) in this case is the upper enable signal HEN. As illustrated in FIG. 3, the resetting signal may be generated by inverting the logical level of the overvoltage protection signal OV by a NOT circuit 6A (inverter).

As illustrated in FIG. 2, for example, each control signal changing circuit 30 preferably includes a tri-state buffer 31 and a pull-up resistor 32 connected to an output terminal of the tri-state buffer 31. The tri-state buffer 31 may be a shut-off circuit to shut off transmission of the switching control signal SW to the associated driving circuit 50. The pull-up resistor 32 may be a logical level fixing circuit to fix the logical level of the control signal SW2, which is to be transmitted to the associated driving circuit 50 instead of the switching control signal SW, at a logical level that turns on the associated switching element 3. Accordingly, each control signal changing circuit 30 may include a shut-off circuit (31) and a logical level fixing circuit (32).

A control terminal of the tri-state buffer 31 receives the overvoltage protection signal OV. When no overvoltage is developed, the logical level of the negative logic overvoltage protection signal OV is high (positive), so that a signal input to the tri-state buffer 31 is output therefrom, with the logical level of the signal remaining unchanged. In other words, the switching control signal SW is transmitted to the lower driving circuit 50L a second driving circuit 52), with the logical level of the switching control signal SW remaining unchanged. When an overvoltage is developed, the logical level of the overvoltage protection signal OV is low (negative), so that an input to the tri-state buffer 31 is shut off, and the output terminal of the tri-state buffer 31 enters a high impedance (Hi-Z) state. In such a case, the logical level of the output terminal is not determined without the pull-up resistor 32. In this embodiment, however, the logical level of the output terminal is fixed at a high level by the pull-up resistor 32 when the output terminal is in the high impedance state. Accordingly, the control signal SW2 whose logical level is at a high level that turns on the associated switching element 3 is transmitted to the lower driving circuit 50L, and the driving signal DS whose signal level turns on the associated switching element 3 is output from the lower driving circuit 50L.

As described above with reference to FIGS. 2 and 3, the logical level of the upper driving signal DSH to be output from the upper driving circuit 50H quickly becomes a low level in accordance with the overvoltage protection signal OV, and the logical level of the lower driving signal DSL to be output from the lower driving circuit 50L quickly becomes a high level similarly in accordance with the overvoltage protection signal OV. In other words, the inverter circuit 10 is quickly brought to the active short-circuit state in accordance with the overvoltage protection signal OV. This makes it possible to reduce or prevent an increase in the direct-current link voltage Vdc.

Referring to FIGS. 2 and 3, a configuration of the driver 2 provided for one of the arms 3A has been described thus far. Referring also to FIG. 4, the following description discusses an exemplary configuration of the driver 2 provided for the arms 3A for a plurality of phases. Similarly to FIG. 3, other protection signals, such as the shut-down command SD, and the alarm signals “ALM” output from the driving circuits 50, for example, are not illustrated in FIG. 4. In this embodiment, one of the upper driving circuit 50H and the lower driving circuit 50L is the first driving circuit 51, and the other of the upper driving circuit 50H and the lower driving circuit 50L is the second driving circuit 52. The inverter controller 20 outputs the switching control signals SW each associated with one of the phases (three phases in this embodiment) to the driving circuits 50. The resetting circuit 60 is connected to each of the first driving circuits 51 for all of the phases. Each control signal changing circuit 30 is connected between the inverter controller 20 and an associated one of the second driving circuits 52 for all of the phases.

Only one resetting circuit 60 is provided irrespective of the number of alternating-current phases. The same resetting signal (enable signal) that is an output from the resetting circuit 60 is input to the enable input terminals EN of the first driving circuits 51 for all of the phases (three phases). The number of control signal changing circuits 30 provided is equal to the number of alternating-current phases. In the present embodiment, the number of control signal changing circuits 30 provided is three because the number of phases is three. Thus, in the present embodiment, the resetting circuit 60 is connected to each of the first driving circuits 51 for all of the phases, and each of the control signal changing circuits 30 is connected between the inverter controller 20 and an associated one of the second driving circuits 52 for all of the phases.

In the embodiment described above with reference to FIGS. 2 and 3, the first driving circuit 51 is the upper driving circuit 50H, and the second driving circuit 52 is the lower driving circuit 50L. In a situation where active short-circuit control is to be exercised, i.e., when a system including the inverter circuit 10 encounters a situation where continuation of operation is not preferable, measures may have to be taken for other circuits, such as the driving circuits 50, in order to cope with such a situation. As illustrated in FIG. 1, the lower switching elements 3L of the inverter circuit 10 have the same negative electrode side potential (N). Suppose that measures have to be taken for other circuits, such as the driving circuits 50, in order to cope with the above situation. In this case, when the lower switching elements 3L for all of the phases are to be turned off, such measures are more simply taken than when the upper switching elements 3H for all of the phases are to be turned off. Examples of such measures include installing backup power supplies to supply power supply voltages to the driving circuits 50. When the lower switching elements 3L have the same negative electrode side potential, there is no need to provide such a backup power supply for each driving circuit 50 (each lower driving circuit 50L) in order to turn off the lower switching elements 3L for all of the phases.

Thus, FIGS. 2 and 3 illustrate the embodiment in which the first driving circuit 51 is the upper driving circuit 50H, and the second driving circuit 52 is the lower driving circuit 50L. When no particular measures, such as those mentioned above, are necessary for the other circuits, however, the first driving circuit 51 may naturally be the lower driving circuit 50L, and the second driving circuit 52 may naturally be the upper driving circuit 50H.

A system including the inverter circuit 10 may encounter a situation where continuation of operation is not preferable owing to a defective condition other than an overvoltage. Failsafe control for the inverter circuit 10 is not limited to active short-circuit control. Examples of failsafe control known include shutdown control that involves turning off all of the switching elements 3 included in the inverter circuit 10. Such shutdown control is preferably quickly exercised similarly to active short-circuit control. As previously described, the resetting circuit 60 provides the resetting signal (ineffective enable signal) to the first driving circuit 51, so that the first driving circuit 51 will also be ready for shutdown control. A circuit similar to the resetting circuit 60 may also be preferably provided for the second driving circuit 52 such that an entirety of the inverter circuit 10 will be ready for shutdown control.

As previously mentioned, the driver 2 receives, in addition to the overvoltage protection signal OV, an inverter protection signal to protect the inverter circuit 10. Because the second driving circuit 52 has to be also ready for active short-circuit control, a resetting circuit provided for the second driving circuit 52 must be a circuit that responds to an inverter protection signal different from the overvoltage protection signal OV, instead of responding to the overvoltage protection signal OV. In this case, the resetting circuit 60 connected to the first driving circuit 51 is a first resetting circuit 60, and another resetting circuit connected to the second driving circuit 52 is a second resetting circuit 70.

As illustrated in FIG. 2, the first resetting circuit 60 is a resetting circuit to set the signal level of the driving signal DS at a signal level that turns off the associated switching element 3 when at least one of the overvoltage protection signal OV and inverter protection signals is effective. The second resetting circuit 70 is a resetting circuit to set the signal level of the driving signal DS at a signal level that turns off the associated switching element 3 when at least one of inverter protection signals other than the overvoltage protection signal OV is effective. Similarly to the first resetting circuit 60, the second resetting circuit 70 is configured to include a second OR circuit 7. The second OR circuit 7 is an OR circuit (NAND circuit) that receives negative logic signals. The second OR circuit 7 receives the signals “SD”, “MDS”, and “ALM” that are negative logic signals similarly to the overvoltage protection signal OV.

As described above, the driver 2 includes the first resetting circuit 60 and the second resetting circuit 70 in addition to the control signal changing circuits 30. This enables the driver 2 to be quickly ready for both of active short-circuit control and shutdown control. Thus, the resetting circuit 60 is preferably connected to each of the first driving circuits 51, each of the control signal changing circuits 30 is preferably connected between the inverter controller 20 and the associated second driving circuit 52, and the second resetting circuit 70 is preferably connected to each of the second driving circuits 52.

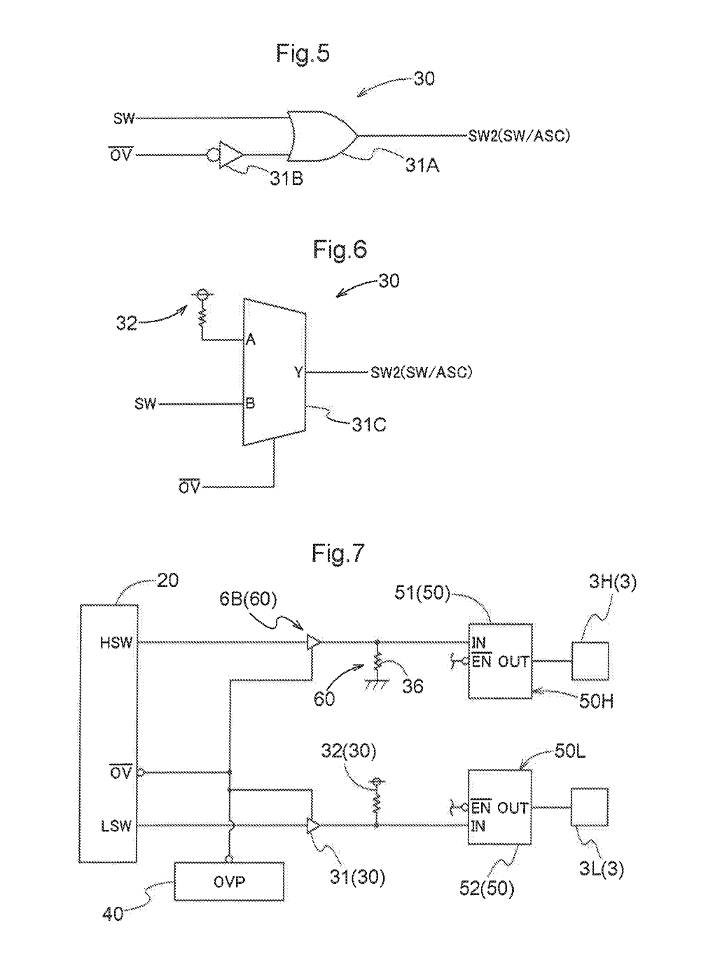

Each control signal changing circuit 30 is not limited to the configuration illustrated in FIGS. 2 and 3, i.e., the configuration that includes the tri-state buffer 31 and the pull-up resistor 32. Each control signal changing circuit 30 may have any other circuit configuration. FIGS. 5 and 6 each illustrate such other configurations.

FIG. 5 illustrates an example of the configuration of the control signal changing circuit 30 that includes a two-input OR circuit 31A. A first input terminal of the two-input OR circuit 31A receives a signal provided by inverting the logical level of the overvoltage protection signal OV by a NOT circuit 31B (inverter). A second input terminal of the two-input OR circuit 31A receives the switching control signal SW. When no overvoltage is developed, the logical level of the first input terminal that receives the overvoltage protection signal OV through the NOT circuit 31B is low, so that a signal whose logical level corresponds to the logical level of the switching control signal SW is output to an output terminal of the two-input OR circuit 31A. When an overvoltage is developed, the logical level of the first input terminal that receives the overvoltage protection signal OV through the NOT circuit 31B is high, so that the logical level of a signal to be output from the output terminal of the two-input OR circuit 31A is fixed at a high level. In this configuration, the control signal changing circuit 30 includes a masking circuit that uses the overvoltage protection signal OV as a masking signal, instead of including a shut-off circuit and a logical level fixing circuit.

FIG. 6 illustrates an example of the configuration of the control signal changing circuit 30 that includes a 2-to-1 multiplexer 31C (selector). A first data input terminal A of the 2-to-1 multiplexer 31C is pulled up, so that its logical level is fixed at a high level. A second data input terminal B of the 2-to-1 multiplexer 31C receives the switching control signal SW. An output control terminal S of the 2-to-1 multiplexer 31C receives the overvoltage protection signal OV. When the logical level of the output control terminal S is low, a signal input to the first data input terminal A is output from a data output terminal Y of the 2-to-1 multiplexer 31C. When the logical level of the output control terminal S is high, a signal input to the second data input terminal B is output from the data output terminal Y. In other words, when the overvoltage protection signal OV is ineffective (high), the switching control signal SW is output from the data output terminal Y on an as-is basis. When the overvoltage protection signal OV is effective (low), the control signal SW2 that is fixed at a high level is output from the data output terminal Y. In this configuration, the 2-to-1 multiplexer 31C is equivalent to a shut-off circuit, and the pull-up resistor 32 for the first data input terminal A is equivalent to a logical level fixing circuit.

FIGS. 2 to 4 illustrate the embodiment in which single resetting circuit 60 (first resetting circuit 60) is provided so as to be shared by the first driving circuits 51. Alternatively, the resetting circuit 60 may be a circuit configured to change the switching control signal SW to a signal fixed at a low level and may be provided for each of the first driving circuits 51 similarly to the control signal changing circuits 30. FIG. 7 illustrates the resetting circuit 60 having such a configuration. FIG. 7 illustrates the configuration of the resetting circuit 60 (or second control signal changing circuit) that includes a tri-state buffer 6B and a pull-down resistor 36 connected to an output terminal of the tri-state buffer 6B similarly to the control signal changing circuit 30.

FIGS. 2 to 4 illustrate the embodiment in which the control signal changing circuits 30 are each provided for an associated one of the second driving circuits 52. Alternatively, only one control signal changing circuit 30 may be provided so as to be shared by the second driving circuits 52 irrespective of the number of alternating-current phases. Although not illustrated, in such a case, the control signal changing circuit 30 transmits the same control signal SW2, whose logical level is such that the associated switching elements 3 are turned on, to the second driving circuits 52 for all of the phases (three phases) irrespective of the logical level of each switching control signal SW.

### Summary of Embodiment

The following description briefly discusses in outline the inverter driver (2) described above.

An aspect of the present disclosure provides an inverter driver (2) including driving circuits (50) configured to transmit driving signals (DS) to a plurality of switching elements (3) included in an inverter circuit (10). The inverter circuit (10) is connected to a direct-current power supply (11) and an alternating-current rotating electric machine (80) and configured to convert multi-phase alternating-current power to direct-current power and convert direct-current power to multi-phase alternating-current power.

The inverter circuit (10) includes a plurality of arms (3A) each provided for an associated one of alternating current phases. The arms (3A) each include a series circuit of an upper switching element (3H) and a lower switching element (3L).

The driving circuits (50) are each configured to relay a switching control signal (SW) so as to transmit the driving signal (DS) to an associated one of the switching elements (3). The switching control signal (SW) is output from an inverter controller (20) that controls the inverter circuit (10). The driving circuits (50) include: an upper driving circuit (50H) to transmit the driving signal (DS (DSH)) to the associated upper switching element (3H); and a lower driving circuit (50L) to transmit the driving signal (DS (DSL)) to the associated lower switching element (3L).

The inverter driver (2) further includes: an overvoltage protector (40), a resetting circuit (60), and control signal changing circuits (30).

The overvoltage protector (40) is configured to output an overvoltage protection signal (OV) when a voltage (Vdc) of a direct-current side of the inverter circuit (10) is equal to or higher than a preset overvoltage threshold value.

The resetting circuit (60) is configured to set, in accordance with at least the overvoltage protection signal (OV), a signal level of the driving signal (DS) to be output from each of the associated driving circuits (50) at a signal level that turns off the associated switching element (3).

The control signal changing circuits (30) are each connected between the inverter controller (20) and the associated driving circuit (50). The control signal changing circuits (30) are each configured to transmit, instead of the switching control signal (SW), a control signal (SW2) to the associated driving circuit (50) in accordance with the overvoltage protection signal (OV). The control signal (SW2) has a logical level that turns on the associated switching element (3) irrespective of a logical level of the switching control signal (SW).

One of the upper driving circuit (50H) and the lower driving circuit (50L) is a first driving circuit (51), and the other of the upper driving circuit (50H) and the lower driving circuit (50L) is a second driving circuit (52). The resetting circuit (60) is connected to each of the first driving circuits (51) for all of the phases. The control signal changing circuits (30) are each connected between the inverter controller (20) and an associated one of the second driving circuits (52) for all of the phases.

In this configuration, a signal to be input to each second driving circuit (52) immediately changes to the active short-circuit control signal (SW2) in accordance with the overvoltage protection signal (OV), without a controller such as the inverter controller (20) being involved. Thus, in the course of active short-circuit control, the switching elements (3) that should be turned on are quickly turned on. The upper and lower switching elements (3) of each arm (3A) need to be prevented from being simultaneously turned on and short-circuited. In other words, in the course of active short-circuit control, the switching element (3) of each arm (3) different from the switching element (3) that should be turned on needs to be turned off. In the above configuration, the signal level of an output from each first driving circuit (51) is immediately set at a signal level that turns off the associated switching element (3) in accordance with the overvoltage protection signal (OV), without a controller such as the inverter controller (20) being involved. Accordingly, each of the arms (3) is brought to a state where active short-circuit control is immediately exercised in accordance with the overvoltage protection signal (OV), i.e., the active short-circuit state, without a controller such as the inverter controller (20) being involved. Consequently, the above configuration enables the inverter circuit (10) to quickly shift to the active short-circuit state when conditions for exercising active short-circuit control are satisfied (e.g., when the overvoltage protection signal (OV) is output).

The control signal changing circuits (30) preferably each include: a shut-off circuit (31) to shut off transmission of the switching control signal (SW) to the associated driving circuit (50); and a logical level fixing circuit (32) to fix the logical level of the control signal (SW2) to be transmitted to the associated driving circuit (50) instead of the switching control signal (SW) at a logical level that turns on the associated switching element (3).

Providing the shut-off circuit (31) makes it possible to suitably shut off transmission of the switching control signal (SW) to the associated switching element (3) through the driving circuit (50). Providing the logical level fixing circuit (32) makes it possible to suitably set the logical level of the control signal (SW2) that is to be transmitted to the associated switching element (3) through the driving circuit (50) instead of the switching control signal (SW). The shut-off circuit (31) and the logical level fixing circuit (32) may be simple in configuration so as to reduce the cost of components. Because the shut-off circuit (31) and the logical level fixing circuit (32) are small in circuit size, signal delay is short. This enables the inverter circuit (10) to quickly shift to the active short-circuit state.

Another aspect of the present disclosure provides the inverter driver (2) that is preferably configured to receive, in addition to the overvoltage protection signal (OV), at least one inverter protection signal (SD, MSD, ALM) to protect the inverter circuit (10).

The resetting circuit (60) is preferably a first resetting circuit (60) to set the signal level of the driving signal (DS) at a signal level that turns off the associated switching element (3) when at least one of the overvoltage protection signal (OV) and the inverter protection signal (SD, MSD, ALM) is effective.

The inverter driver (2) preferably further includes a second resetting circuit (70) to set the signal level of the driving signal (DS) at a signal level that turns off the associated switching element (3) when the at least one inverter protection signal (SD, MSD, ALM) other than the overvoltage protection signal (OV) is effective.

The first resetting circuit (60) is preferably connected to each of the first driving circuits (51). The control signal changing circuits (30) are preferably each connected between the inverter controller (20) and the associated second driving circuit (52). The second resetting circuit (70) is preferably connected to each of the second driving circuits (52).

When the overvoltage protection signal (OV) is effective so as to enable the inverter circuit (10) to enter the active short-circuit state, this configuration allows the first resetting circuit (60) to reset an output from each first driving circuit (51) and allows each second driving circuit (52) to output the driving signal (DS) based on the control signal (SW2) transmitted from the associated control signal changing circuit (30). When the protection signal, which is different from the overvoltage protection signal (OV) and serves to protect the inverter driver (2), is effective, this configuration allows the first resetting circuit (60) to reset an output from each first driving circuit (51) and allows the second resetting circuit (70) to reset an output from each second driving circuit (52). Thus, not only active short-circuit control but also shutdown control is exercised over the inverter circuit (10).

Each of the first driving circuits (51) is preferably the upper driving circuit (50H), and each of the second driving circuits (52) is preferably the lower driving circuit (50L).

In a situation where active short-circuit control is to be exercised, i.e., when a system including the inverter circuit (10) encounters a situation where continuation of operation is not preferable, measures may have to be taken for other circuits, such as the driving circuits (50), in order to cope with such a situation. The lower switching elements (3) have the same negative electrode side potential. Suppose that measures have to be taken for other circuits, such as the driving circuits (50), in order to cope with the above situation. In this case, when the lower switching elements (3L) for all of the phases are to be turned off, such measures are more simply taken than when the upper switching elements (3H) for all of the phases are to be turned off. Examples of such measures include installing backup power supplies to supply power to the driving circuits (50). When the lower switching elements (3L) have the same negative electrode side potential, there is no need to provide such a backup power supply for each driving circuit (50), i.e., each lower driving circuit (50L), in order to turn off the lower switching elements (3L) for all of the phases.

1. An inverter driver comprising:
driving circuits configured to transmit driving signals to a plurality of switching elements included in an inverter circuit, the inverter circuit being connected to a direct-current power supply and an alternating-current rotating electric machine and configured to convert multi-phase alternating-current power to direct-current power and convert direct-current power to multi-phase alternating-current power, wherein:
the inverter circuit includes a plurality of arms each provided for an associated one of alternating-current phases, the arms each including a series circuit of an upper switching element and a lower switching element, and
the driving circuits are each configured to relay a switching control signal so as to transmit the driving signal to an associated one of the switching elements, the switching control signal being output from an inverter controller that controls the inverter circuit, the driving circuits including an upper driving circuit to transmit the driving signal to the associated upper switching element, and a lower driving circuit to transmit the driving signal to the associated lower switching element;
an overvoltage protector configured to output an overvoltage protection signal when a voltage of a direct-current side of the inverter circuit is equal to or higher than a preset overvoltage threshold value;
a resetting circuit configured to set, in accordance with at least the overvoltage protection signal, a signal level of the driving signal to be output from each of the associated driving circuits at a signal level that turns off the associated switching element; and
control signal changing circuits each connected between the inverter controller and the associated driving circuit, the control signal changing circuits each being configured to transmit, instead of the switching control signal, a control signal to the associated driving circuit in accordance with the overvoltage protection signal, the control signal having a logical level that turns on the associated switching element irrespective of a logical level of the switching control signal, wherein:
one of the upper driving circuit and the lower driving circuit is a first driving circuit, and the other of the upper driving circuit and the lower driving circuit is a second driving circuit, and
the resetting circuit is connected to each of the first driving circuits for all of the phases, and the control signal changing circuits are each connected between the inverter controller and an associated one of the second driving circuits for all of the phases.

2. The inverter driver according to claim 1, wherein
the control signal changing circuits each include
a shut-off circuit to shut off transmission of the switching control signal to the associated driving circuit, and
a logical level fixing circuit to fix the logical level of the control signal to be transmitted to the associated driving circuit instead of the switching control signal at a logical level that turns on the associated switching element.

3. The inverter driver according to claim 2, wherein
the inverter driver is configured to receive, in addition to the overvoltage protection signal, at least one inverter protection signal to protect the inverter circuit,
the resetting circuit is a first resetting circuit to set the signal level of the driving signal at a signal level that turns off the associated switching element when at least one of the overvoltage protection signal and the inverter protection signal is effective,
the inverter driver further comprises a second resetting circuit to set the signal level of the driving signal at a signal level that turns off the associated switching element when the at least one inverter protection signal other than the overvoltage protection signal is effective, and
the first resetting circuit is connected to each of the first driving circuits, the control signal changing circuits are each connected between the inverter controller and an associated one of the second driving circuits, and the second resetting circuit is connected to each of the second driving circuits.

4. The inverter driver according to claim 3, wherein
each of the first driving circuits is the upper driving circuit, and each of the second driving circuits is the lower driving circuit.

5. The inverter driver according to claim 1, wherein
the inverter driver is configured to receive, in addition to the overvoltage protection signal, at least one inverter protection signal to protect the inverter circuit,
the resetting circuit is a first resetting circuit to set the signal level of the driving signal at a signal level that turns off the associated switching element when at least one of the overvoltage protection signal and the inverter protection signal is effective,
the inverter driver further comprises a second resetting circuit to set the signal level of the driving signal at a signal level that turns off the associated switching element when the at least one inverter protection signal other than the overvoltage protection signal is effective, and
the first resetting circuit is connected to each of the first driving circuits, the control signal changing circuits are each connected between the inverter controller and an associated one of the second driving circuits, and the second resetting circuit is connected to each of the second driving circuits.

6. The inverter driver according to claim 1, wherein
each of the first driving circuits is the upper driving circuit, and each of the second driving circuits is the lower driving circuit.

7. The inverter driver according to claim 2, wherein
each of the first driving circuits is the upper driving circuit, and each of the second driving circuits is the lower driving circuit.

8. The inverter driver according to claim 5, wherein
each of the first driving circuits is the upper driving circuit, and each of the second driving circuits is the lower driving circuit.
